(19) United States
(12) Patent Application Publication
(10) Pub. No.: US 2005/0162399 A1
(43) Pub. Date: Jul. 28, 2005

(54) Displaying and inputting apparatus

(75) Inventor: Junji Yamada, Yokohama-shi (JP)

Correspondence Address: FOLEY AND LARDNER;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/762,285

(22) Filed: Jan. 23, 2004

(51) Int. Cl. G09G 5/00

(52) U.S. Cl. 345/173

(57) ABSTRACT

A displaying and inputting apparatus includes a touch panel display, a layout information memory which stores a plurality of layout information which sets a layout of a plurality of functions displayed on the touch panel display, a selector which selects one layout information from the plurality of layout information, and a control unit which displays a function on a touch panel display based on the layout information selected by the selector.

### BACKGROUND OF THE INVENTION

1. Field of the Invention

The present invention relates to a displaying and inputting apparatus having a touch panel to accept instructions input by the user.

2. Description of the Related Art

A displaying and inputting apparatus having a touch panel display is used as a control panel of a copier, for example. When making a copy, the user touches the function displayed on the touch panel display to change the level of a menu screen, calls the touch key assigned to a function of a desired output form, and touches that touch key to instruct a copier to make a copy. The operation like the process of calling a desired output form hierarchically is troublesome for the user. Further, a displaying and inputting apparatus is generally provided stationarily in a copier, and the information displayed on a touch panel display is arranged to be displayed in a previously specified layout. Thus, a desired touch key may be displayed at a location difficult for the user to operate, or the display is hard to see for some users, depending on the location to install a copier.

Therefore, there is a need for a displaying and inputting apparatus which can change the display on a touch panel display for ease of operations by the user.

### BRIEF SUMMARY OF THE INVENTION

According an aspect of the present invention, there is provided a displaying and inputting apparatus comprising a touch panel display; a layout information memory which stores a plurality of layout information which sets a layout of a plurality of functions displayed on the touch panel display; a selector which selects one layout information from the plurality of layout information; and a control unit which displays the function on the touch panel display based on the layout information selected by the selector.

Objects and advantages of the invention will be apparent from the description which follows, or may be learned by practice of the invention.

### BRIEF DESCRIPTION OF THE SEVERAL VIEWS OF THE DRAWING

The accompanying drawings illustrate embodiments of the invention, and together with the general description given above and the detailed description of given below, serve to explain the principles of the invention.

FIG. 1 is a schematic external view of the MFP used in a first embodiment of the present invention, seen from the side;

FIG. 2 shows a control panel placed in the upper part of the MFP;

FIG. 3 shows the display area of a touch panel display;

FIG. 4 is a block diagram showing the principal configuration of a control panel;

FIG. 5 shows a layout information memory;

FIG. 6 is a table showing an example of right-side layout information and left-side layout information;

FIG. 7 shows a layout of right-side layout information;

FIG. 8 shows a layout of left-side layout information;

FIG. 9 is a flowchart showing a display changing process;

FIG. 10 shows a menu display based on the right-side layout information;

FIG. 11 shows a user layout information memory provided in a second embodiment;

FIG. 12 is a flowchart showing a registration process performed in a user set mode;

FIG. 13 is a table showing an example of user layout information;

FIG. 14 is a flowchart showing a user layout information reading process;

FIG. 15 shows a menu display based on user layout information, and a shaded menu display based on user layout information;

FIG. 16 is a block diagram showing the principal configuration of a control panel used in a third embodiment;

FIG. 17 is a flowchart showing a user layout information displaying process;

FIG. 18 shows a selected times information memory in a fourth embodiment;

FIG. 19 is a flowchart showing a process of storing the date of a function selected;

FIG. 20 is a flowchart showing a layout information displaying process to generate layout information;

FIG. 21 shows another control panel; and

FIG. 22 shows the display area of another touch panel display.

### DETAILED DESCRIPTION OF THE INVENTION

Hereinafter, embodiments of the present invention will be described with reference to the accompanying drawings. In each embodiment, the invention is applied to the control panel 1 of a multifunction peripheral (MFP) 100 which has a plurality of functions, such as a copy function, a scanner function, a printer function and a communication function.

### First Embodiment

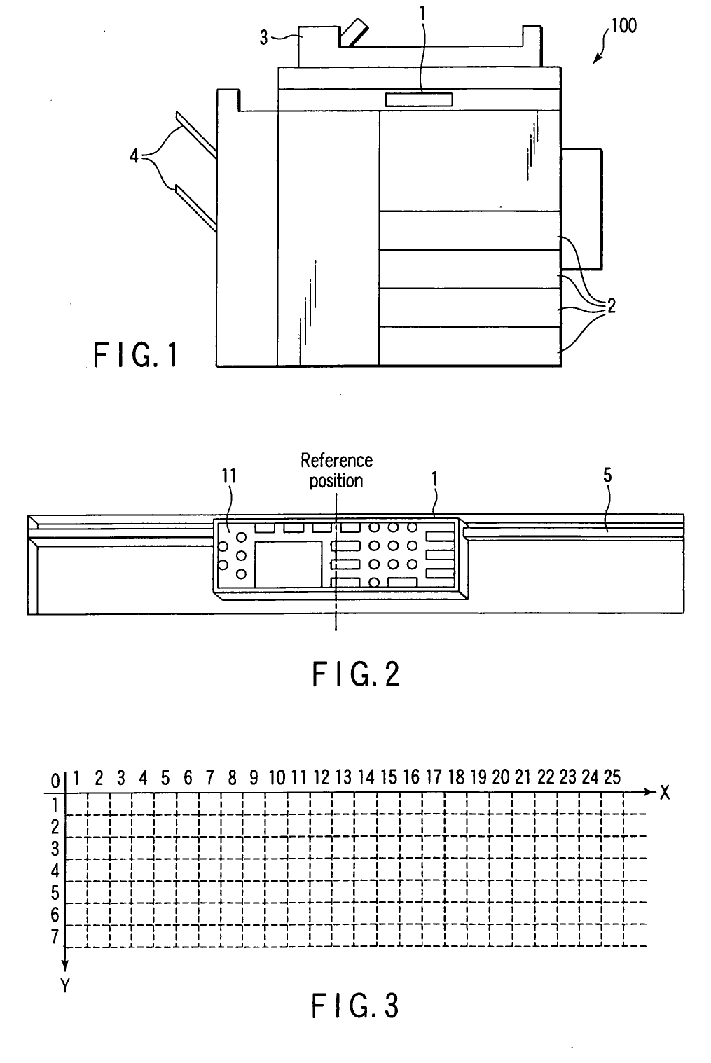

FIG. 1 is a schematic external view of MFP 100 seen from the side. As shown in FIG. 1, the MFP has a control panel (displaying and inputting apparatus) 1, a paper cassette 2 to load paper, an auto document feeder (ADF) 3 to read continuously a plurality of documents, and a paper eject tray 4 to stack paper ejected. The internal configuration of the MFP 100 is similar to the conventional one, and its detailed explanation will be omitted. The control panel 1 will be explained in detail.

FIG. 2 shows the control panel 1 placed in the upper part of the MFP 100. Only a touch panel display 11 is used to input and display data on the control panel 1. Therefore, the touch panel display 11 is used to display all the information that the MFP informs to the user and all the instructions that the user input to the MFP 100. Further, as shown in the drawing, the control panel 1 has a slide mechanism which moves along the length direction of a bar-like member 5. Therefore, the slide mechanism can move the control panel 1 to the left and the right in the lengthwise direction of the bar-like member 5. Even if it is hard for the user to use the control panel 1, the position of the control panel 1 can be adjusted by providing the MFP 100 at an appropriate position. The movable control panel 1 has a reference position at almost the middle of the moving area.

FIG. 3 shows the display area of the touch panel display 11 of the control panel 1. In this embodiment, the display area is expressed by the X-Y coordinates taking the horizontal direction on the X-axis, 0-X25, and the vertical direction on the Y-axis, 0-Y7.

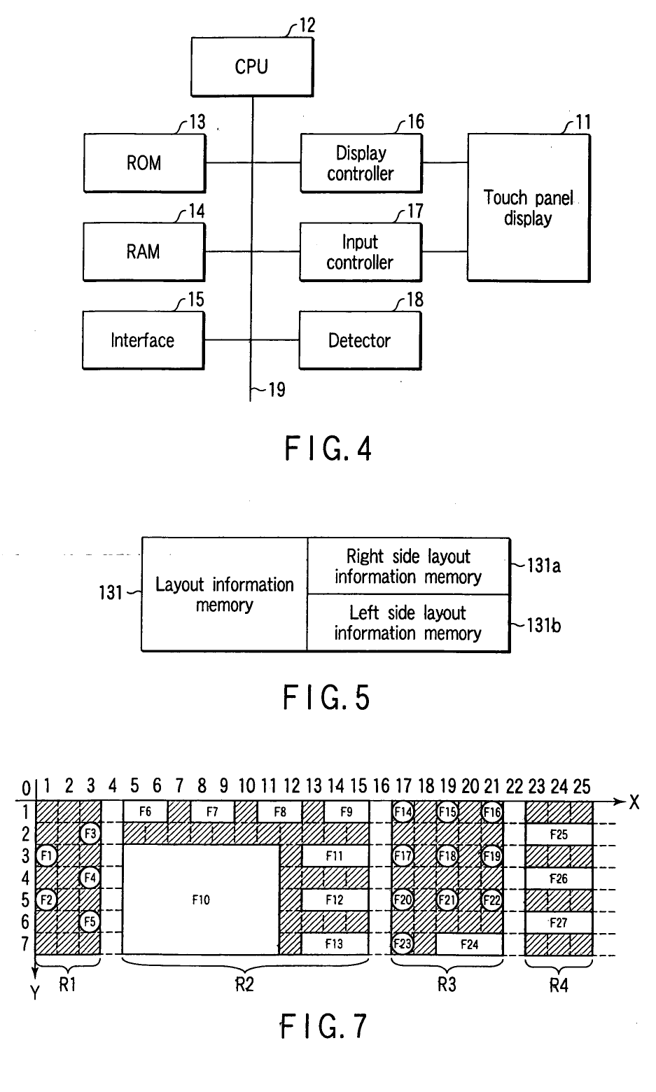

FIG. 4 is a block diagram showing the principal configuration of the control panel 1. The control panel 1 comprises a CPU 12, a ROM 13, a RAM 14, an interface 15, an input controller 17, a display controller 16, a touch panel display 11, and a detector 18. The CPU 12, ROM 13, RAM 14, interface 15, display controller 16, input controller 17 and detector 18 etc are connected by a bus line 19 such as a system bus.

The CPU 12 controls the control panel 1. The ROM 13 stores the control program to be executed by the CPU 12, and also layout information described later. The RAM 14 has a work section used to execute the control program stored in the ROM 13, and an area to store various information. The RAM 14 can hold data by using the backup power supply from the MFP 100. The interface 15 connects the scanner, printer and image processor of the MFP 100.

The display controller 16 displays the functions executable by the MFP 100 on the touch panel display 11 under the control of the CPU 12. In this embodiment, the display controller 16 can control color display. Under the control of CPU 12 the input controller 17 detects that the function displayed on the touch panel display 11 is touched, and accepts instructions input by the user. In the touch panel display 11, the displayed and touched function is performed by the MFP 100 in the same as in the conventional one. Detailed explanation is omitted.

The detector 18 detects the position to which the control panel 1 is moved from the reference position by the slide mechanism. The reference position is at almost the middle of the moving area of the control panel 1 as described above. Rightward or leftward movement from this reference position is detected. More specifically, a sensor to detect the rear side is provided in the control panel 1. In the mounting surface of the control panel 1, a slit is cut on the right-side of the reference position along the moving direction. No slits are provided on the left-side. Whether the control panel 1 is in the right-side or left-side of the reference position is detected in accordance with whether the sensor detects the slit. In this specification, the “right-side” means the right-side for the user who is operating the control panel 1, and the “left-side” means the opposite side.

FIG. 5 shows a layout information memory 131 which stores layout information read from the ROM 13. The layout information memory 131 stores the layout information to set the layout of displaying the functions of the MFP 100 as a menu on the touch panel display 11 of the control panel 1. The functions of the MFP 100 displayed in this menu are functions F1 to F27. Assigned to the functions F1 to F27 are numerals “0”-“9”, “reset” to clear settings, “stop” to stop operations, “start” to execute operations, “magnify/reduce” to magnify/reduce original images, and “color” to specify a color. In this embodiment, the important or often using keys “reset”, “stop” and “start” are assigned to the functions F25 to F27, and the numeral keys “0” to “9” are assigned to the functions F14 to F23. The “magnify/reduce” and “color” functions have hierarchical structure, and call a plurality of menus when the input is accepted. However, for simplicity, explanation will be given on only the functions of the highest-level menu displayed in the standby state. The layout information memory 131 has a right-side layout information memory 131a which stores the right-side layout information to set the layout to display the functions when the control panel 1 moves to the right and a left-side layout information memory 131b which stores the left-side layout information to set the layout to display the functions when the control panel 1 moves to the left-side.

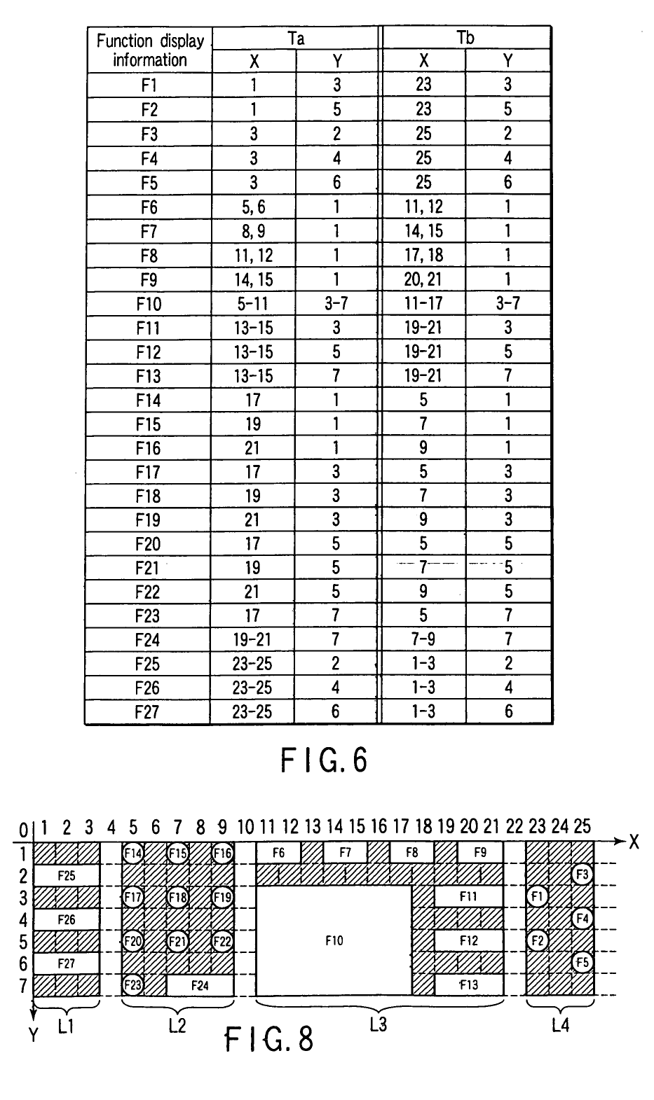

FIG. 6 Ta is a table showing the right-side layout information. This table Ta sets the area in the X-Y coordinates on the touch panel display 11 to display the functions assigned to the functions F1 to F27, when the control panel 1 moves to the right-side. FIG. 7 shows the layout to display the functions F1 to F27 set in the table Ta, on the touch panel display 11. FIG. 6 Tb is a table showing the left-side layout information. This table Tb sets the area in the X-Y coordinates on the touch panel display 11 to display the functions assigned to the functions F1 to F27, when the control panel 1 moves to the left-side. FIG. 8 shows the concrete layout to display the functions F1 to F27 set in the table Tb on the touch panel display 11.

As shown in FIG. 7 and FIG. 8, when the area on the touch panel display 11 is expressed by (X, Y), there is correspondence between the area R1 (X=1−3, Y=1−7), area R2 (X=5−15, Y=1−7), area R3 (X=17−21, Y=1−7) and R4 (X=23−25, Y=1−7) of the layout based on the right-side layout information, and the area L4 (X=23−25, Y=1−7), area L3 (X=11−21, Y=1−7), area L2 (X=5−9, Y=1−7) and area L1 (X=1−3, Y=1−7) of the layout based on the left-side layout information.

Therefore, when the control panel 1 moves to the right, the functions F25 to F27 assigned to the important or often using keys “reset”, “stop” and “start” are placed at the end of the right-side on the touch panel display 11. In this case, the functions F14 to F24 assigned to the numeral keys to be next often used are placed next to F25 and closer to the reference position. When the control panel 1 moves to the left, the functions are placed on the left-side. Namely, when the menu is displayed based on the right-side layout information, the keys to be often used are placed on the right-side and easy to be depressed by a right-handed person. When the menu is displayed based on the left-side layout information, the keys to be often used are placed on the left-side and easy to be depressed by a left-handed person.

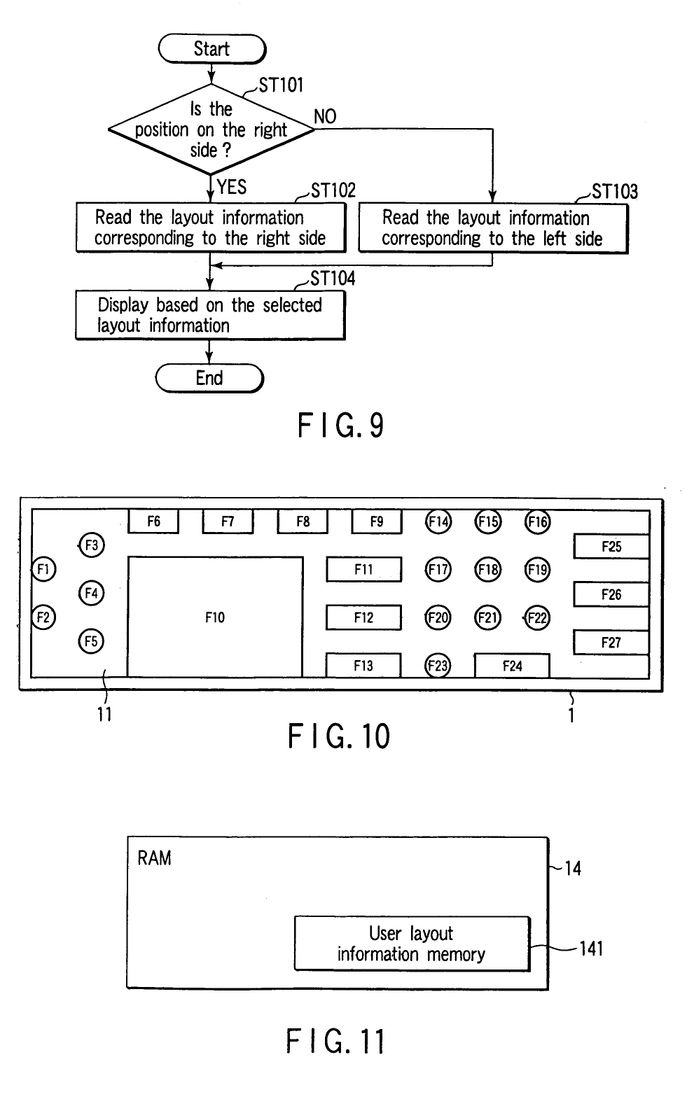

Next, it will be explained how the CPU 12 switches the menu display displayed on the touch panel display 11, based on the position of the control panel 1 detected by the detector 18. FIG. 9 is a flowchart showing the display switching process.

In step ST 101, the CPU 12 monitors the signal from the detector 18 and determines whether the position is on the right-side or left-side. If the position is on the right-side, the process goes to step ST 102. If the position is on the left-side, the process goes to step ST 103. In step ST 102, the CPU 12 reads the right-side layout information stored in the right-side layout information memory 131a of the ROM 13. In step ST 103, the CPU 12 reads the left-side layout information stored in the left-side layout information memory 131b of the ROM 13. In step ST 104, the CPU 12 controls the display controller 16, whereby the menu is displayed on the touch panel display 11 based on the right-side layout information or left-side layout information selected by the above determination.

FIG. 10 shows a menu displayed by the touch panel display 11 based on the right-side layout information of FIG. 7. The menu of the touch panel display 11 is displayed based on the left-side layout information at the position shown in FIG. 8.

With the control panel 1, it is possible to change the menu display of the touch panel display 11 according to the position of the control panel 1 moved by the slide mechanism. Therefore, the control panel 1 can display according to the moved position, and the functions in the menu display can be arranged for easy operation when the control panel 1 is moved. Further, the user can select the menu display according to his/her dominant hand, merely by moving the control panel 1 a little near the reference position.

In the configuration of this embodiment, the detector 18 detects the position of the control panel 1 moved by the slide mechanism. Nonetheless, it is possible to change this configuration as follows. For example, the detector 18 can display the function to change the menu display on the touch panel display 11. The input is regarded as detection of input for switching. Further, the control panel 1 can be removed from the MFP 100 and can communicate with a communication unit provided at the reference position in the MFP 100, by radio communication using, for example infrared rays. The detector 18 can detect the position of the control panel 1 based on the communication.

Hereinafter, a second embodiment to a fourth embodiment will be described. In the following embodiments, the control panel 1 does not have a slide mechanism or a detector 18 and is located at a predetermined position. The ROM 13 sets the default layout information to display each function as a menu on the touch panel display 11.

### Second Embodiment

A second embodiment will be explained. The same reference numerals designate the same components as those in the above-mentioned embodiment, and detailed explanation will be omitted. The second embodiment is different from the first embodiment only in that a user layout information memory 141 storing the user layout information described later is provided in the RAM 14 as shown in FIG. 11. The control panel 1 has a function to register users. The user layout information memory 141 stores the user layout information for each registered user.

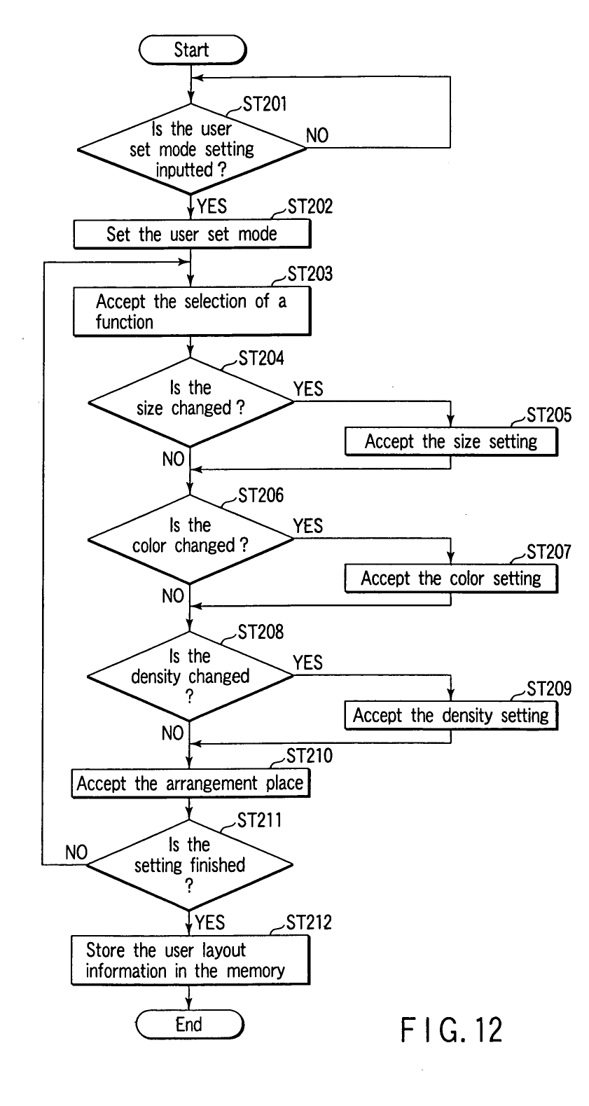

Next, the registration process performed in the user set mode to register the user layout information that the user customizes the function, color and density etc will be described with reference to the flowchart of FIG. 12. The user selects, for example, the user set mode by calling a screen to input the user registration number from the menu, and inputting the user's registration number.

In step ST 201, the CPU 12 accepts the input from the touch panel display 11, and checks whether that input instructs to set the user set mode. If the CPU 12 determines that the user set mode is instructed, the process goes to step ST 202. In step ST 202, the CPU 12 reads a control program for the user to set a layout from the ROM 13, for example, and display it on the touch panel display 11. This sets the user set mode.

In step ST 203, the CPU 12 accepts a function selected by the user, based on the guide on the set screen. When accepting selection of this function, the CPU 12 determines whether to change the size to display that function in step ST 204, to change the display color in step ST 206, and to change the display density in step ST 208. If yes in each step, the CPU 12 accepts the settings to change the size in step ST 205, to change the display color in step ST 207, and to change the display density in step ST 209. In step ST 210, the CPU 12 accepts the setting of the place to arrange the set keys.

In step ST 211, the CPU 12 determines whether the end of user setting is accepted. If the end is not accepted, the process goes to step ST 203, and the layout of displaying functions is registered and so on. If the end is accepted, the process goes to step ST 212. In step ST 212, the CPU 12 stores the user layout information set as described above into the user layout information memory 141 of the RAM 14 by relating it to the registration number of that user.

In the above registration process, the user calls and registers a function to display. It is possible to delete previously the display of unnecessary functions from default setting and then register a new function to display.

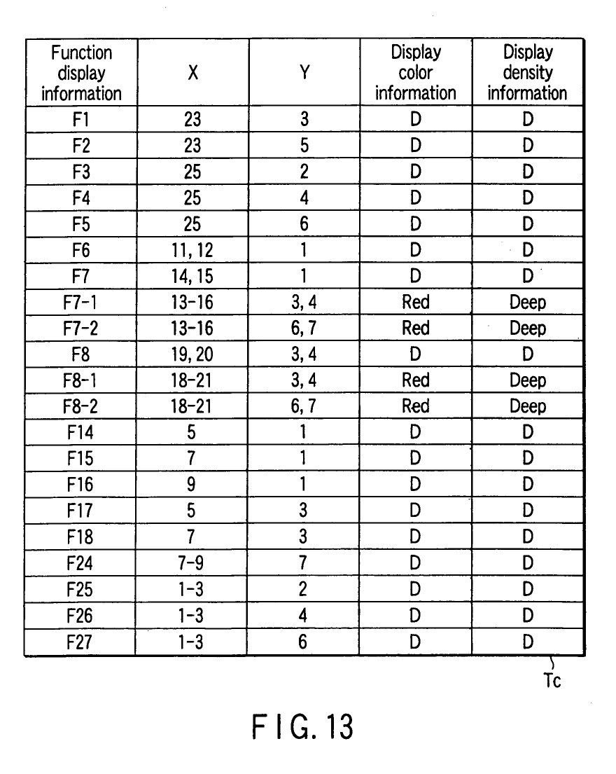

FIG. 13 is a table Tc showing an example of the user layout information registered as described above. Unlike the tables Ta and Tb showing the layout information in the first embodiment, F13 is deleted from the function F9, F23 is deleted from F19. The functions F7-1, F7-2, F8-1 and F8-2 are newly provided. The functions F7-1 and F7-2 are read hierarchically from F7. The functions F8-1 and F8-2 are read hierarchically from F8. The area in the X-Y coordinates, display color information and display density information are stored relating to the function display information indicating the displaying functions. “D” in the display color information and display density information in the table Tc means the default setting. The display color is set to “black” in default, and the display density is set to medium. The functions F7-1, F7-2, F8-1 and F8-2 newly set by the user are set larger than in the area to display the other functions. The display color information is set to “red”, and the display density information is set to “deep density”.

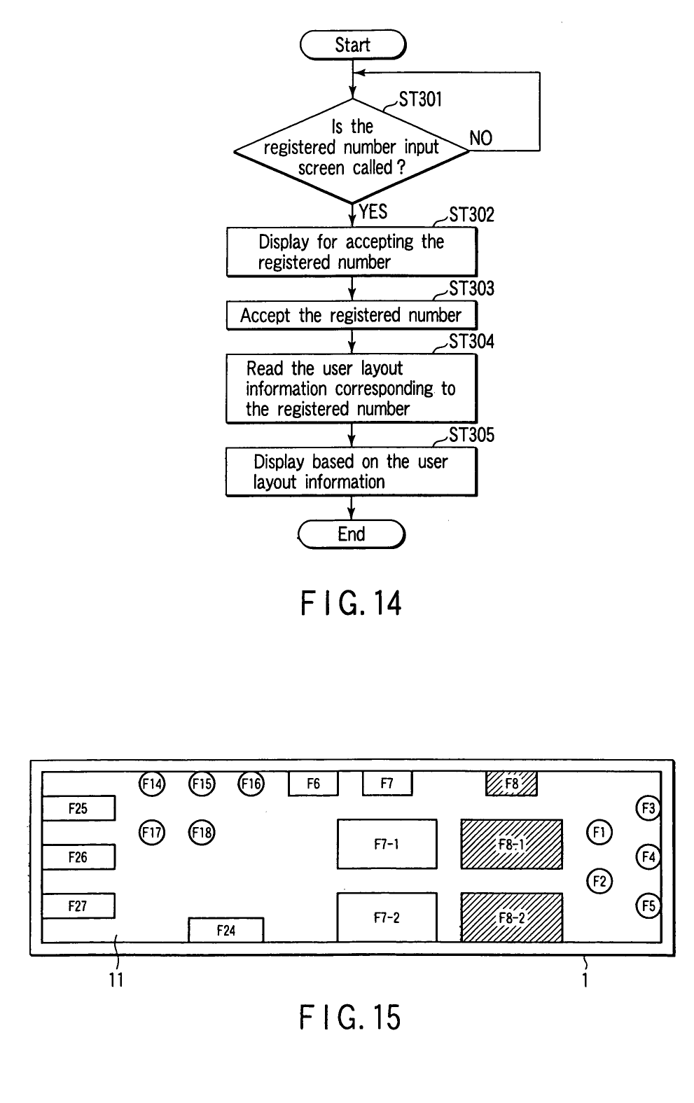

Next, explanation will be given on the process of calling the user layout information, which is set by the user in the user layout information memory 141, as a menu. FIG. 14 is a flow chart showing the user layout information reading process.

In step ST 301, the CPU 12 accepts the instruction to call a screen to input a user registration number from the menu screen displayed based on the default layout information. In step ST 302, the CPU 12 displays a screen to accept a registration number input on the touch panel display 11. Then, in step ST 303, the CPU 12 accepts the inputted registration number. In step ST 304, the CPU 12 searches the user layout information memory 141 of the RAM 14 for the user layout information corresponding to the registration number, and reads it. In step ST 305, the CPU 12 displays a menu on the touch panel display 11, based on the user layout information read.

FIG. 15 shows a menu display based on the user layout information shown in the table Tc. The functions F9 to F13 or the functions F19 to F23 are not displayed, deleted by the user. The newly set functions F7-1, F7-2, F8-1 and F8-2 are displayed. The functions F7-1, F7-2, F8-1 and F8-2 newly set by the user are displayed larger than the other functions, in red and deep density.

Therefore, the user can easily change the customized menu by registering previously the layout of favorite functions, functions to be often used and functions which cannot be called unless searching the hierarchy deeply, in the user set mode. Since the layout, size, color and density of the displaying functions can be freely set and the customizing function is improved, the display of desired functions can be made noticeable. Therefore, the time required by the user to select a menu and instruct the MFP 100 to execute a function through the control panel 1 can be reduced. This renders the MFP 100 more easy to operate.

The items settable by the user are not limited to the above-mentioned items, and it is also possible to select shaded display and icons.

### Third Embodiment

A third embodiment will be explained. The same reference numerals are given to the same components as those in the above-mentioned second embodiment, and detailed explanation will be omitted. This embodiment is different from the second embodiment only in that a user layout information memory 141 is provided in a movable storage medium. Provided in the RAM 14 is a display layout information setting unit 142 which sets to select one of the default layout information and the user layout information, both stored in the user layout information memory 141 of the storage medium. The setting of the display layout information setting unit 142 can be previously determined.

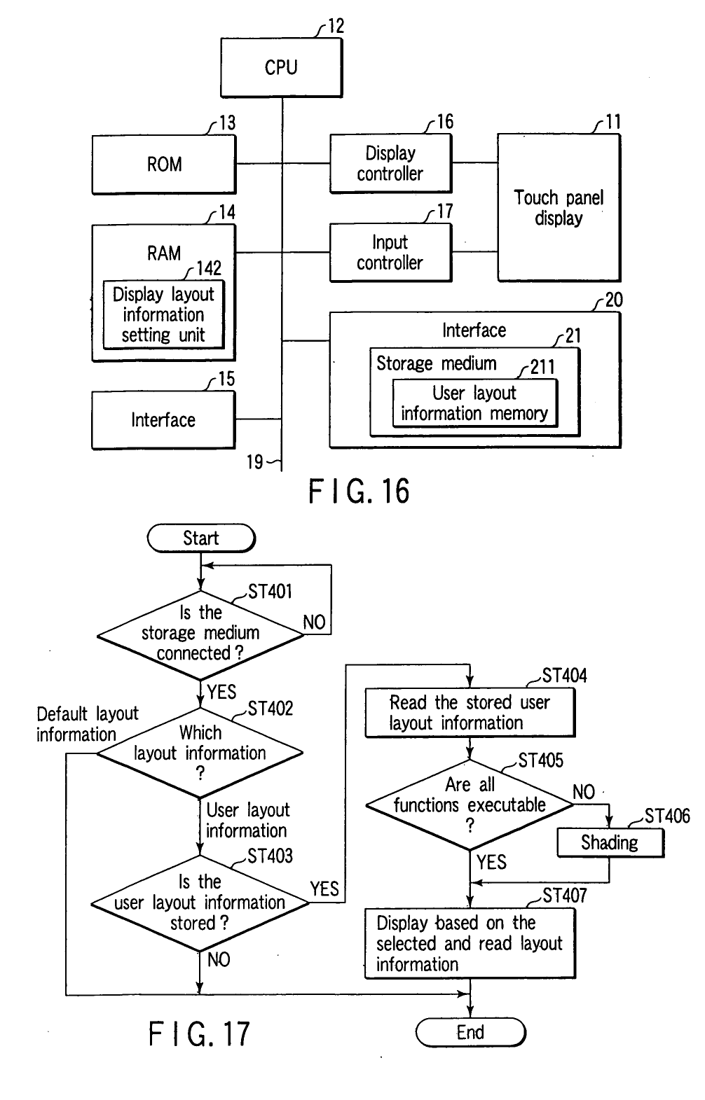

FIG. 16 is a block diagram showing the principal configuration of the control panel 1. As shown in the drawing, the CPU 12 is connected to an interface 20 through the bus line 19. This interface 20 is used to write or read information in/from the movable storage medium 21 like a memory card. A user layout information memory 211 is provided in the storage medium 21, which stores the user layout information. Unlike the second embodiment, one user layout information set for the user having the storage medium 21 is stored.

How the CPU 12 displays a menu based on the user layout information stored in the storage medium 21, on the touch panel display 11, will be described. FIG. 17 is a flow chart showing the process of displaying the user layout information.

In step ST 401, the CPU 12 determines whether the storage medium 21 is connected to the interface 20. If the storage medium 21 is connected, the process shifts from the standby state to step ST 402.

In step ST 402, the CPU 12 determines whether the display layout information setting unit 142 of the RAM 14 is set to select the default layout information or the user layout information stored in the storage medium 21. To select the default layout information, the menu displayed on the touch panel display 11 needs not to be changed, and the process is finished. To select the user layout information, the process goes to step ST 403.

In step 403, the CPU 12 determines whether the user layout information is stored in the connected storage medium 21. The process is terminated if the user layout information is not stored. The process goes to step ST 404 if the user layout information is stored. In step ST 404, the CPU 12 reads the user layout information from the user layout information memory 211 and stores it in a predetermined area of the RAM 14.

In step ST 405, the CPU 12 checks whether all functions set in the read user layout information are executable. Because, if the user layout information is set in other MFP, it should be determined whether all functions of the user layout information stored in the storage medium 21 are executable. If No, the process goes to step ST 406. In step ST 406, the CPU 12 displays the non-executable functions in shaded form on the touch panel display 11.

In step ST 407, the CPU 12 displays a menu on the touch panel display 11 based on the read user layout information or one of the shaded user layout information.

The shaded functions F8, F8-1 and F8-2, all shaded in FIG. 15, indicate the menu displayed on the basis of the shaded user layout information. This menu, in the functions of the MFP 100 provided with the control panel 1, indicates the case where the functions displayed by the functions F8, F8-1 and F8-2 based on the user layout information read from the storage medium 21 are not executable. Therefore, as shown in the drawing, F8, F8-1 and F8-2 are shaded to indicate that these functions are not executable.

Therefore, the user can easily display the user layout information set in other MFP as a menu, as well as those set in the using MFP 100, by connecting the storage medium 21 which stores the user layout information in the user layout information memory 211, to the control panel 1 of the using MFP 100.

With the above-mentioned configuration, the user can reduce the time required from menu selection to input, by changing the menu layout to the favorite one, when using the higher-level model having complex functions in the same series MFP. The non-executable functions are shaded when displayed, and the user can visibly confirm that the shaded functions are not executable. The menu may not include the optional functions shaded.

Movable storage media such as a floppy disk (FD) and compact disk (CD) may be used. A drive for reading the use layout information from the FD or CD may be provided in an external unit with the control panel 1 installed (MFP 100 in this embodiment).

### Fourth Embodiment

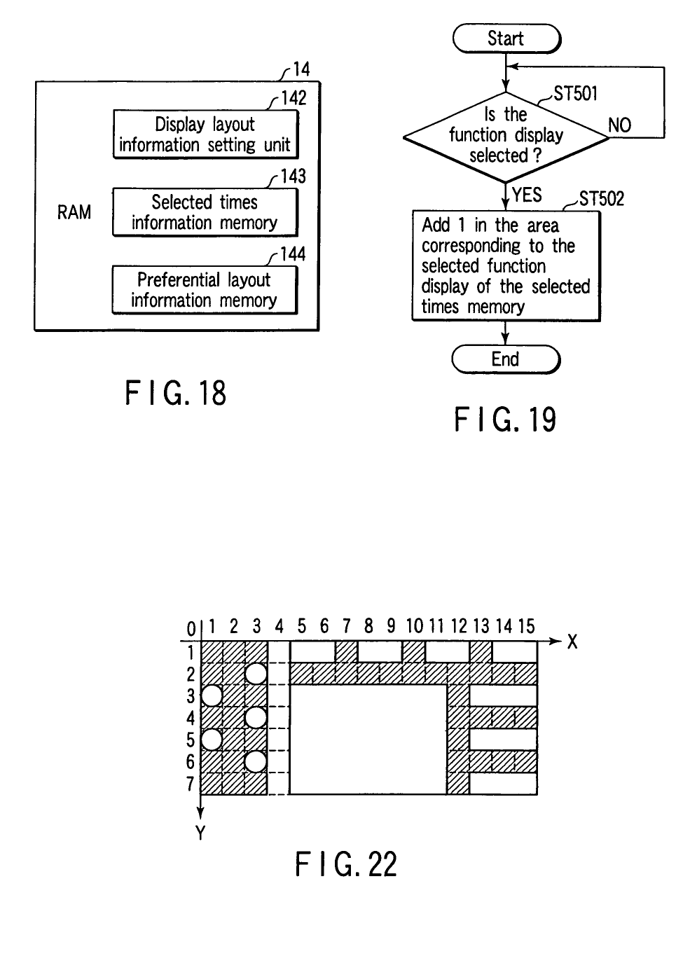

A fourth embodiment will be explained. The same reference numerals are given to the same components as those in the above-mentioned first embodiment, and detailed explanation will be omitted. The fourth embodiment is different from the first embodiment only in that a display layout information setting unit 142, a selected times information memory 143 and a preferential layout information memory 144 are provided in a part of the area of the RAM 14, as shown in FIG. 18. The selected times information memory 143 stores the number of times the displayed function is selected. The preferential layout information memory 144 stores the preferential layout information for displaying the often selected functions preferentially. The display layout information setting unit 142 is set to select one of the default layout information and the preferential layout information, both stored in the preferential layout information memory 144.

FIG. 19 is a flowchart showing the process of storing selection of functions in the selected times information memory 143. In step ST 501, the CPU 12 determines whether any function is selected. If any function is selected, the process goes to step ST 502. In step ST 502, the CPU 12 adds “1” in the area to store the number of selected times corresponding to the selected function, in the selected times information memory 143. This operation is repeated, and the number of times selected is stored for each function in the selected times information memory 143. This function of storing the number of times selected is excluded for the functions assigned to those required for operation, such as numeral keys “0”-“9”, “reset key”, “start key”, and “stop key”.

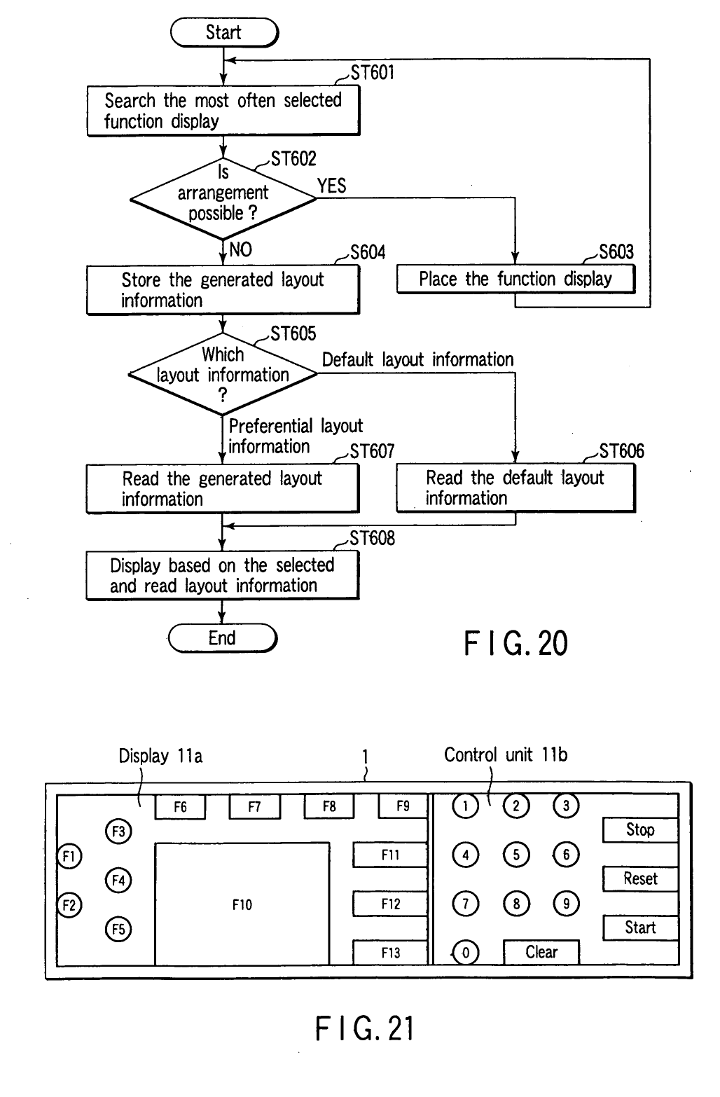

FIG. 20 is a flowchart showing the process of generating preferential layout information and displaying a menu on the touch panel display 11 based on the generated preferential layout information. The preferential layout information is generated when the power is turned on, for example.

In step ST 601, the CPU 12 searches the selected times information memory 143, and selects the function most often selected. Next, in step ST 602, the CPU 12 checks whether the selected function can be placed for displaying. Namely, the CPU 12 determines whether the function selected can be placed in the X-Y area of the touch panel display 11. If it can be placed, the process goes to step ST 603. In step ST 603, the CPU 12 arranges the selected function. Then, the process goes back to step ST 601, and the second most often selected function is selected, and the above-mentioned steps are repeated. In this placement procedure, when a function is placed for displaying in the X-Y area, the next function is placed outside that area.

The placement for displaying a function is performed as described above. In step ST 602, if no more placement is possible, the process goes to step ST 604, without making placement for displaying that function. In step ST 604, the CPU 12 stores the placement set by the process in steps ST 601 to ST 603, in the preferential layout information memory 144 of the RAM 14.

In step ST 605, the CPU 12 selects one of the default layout information and the preferential layout information, both stored in the RAM 14. This selection is done based on the setting in the display layout information setting unit 142 of the RAM 14. The CPU 12 reads the default layout information in step ST 606, and the preferential layout information stored in the preferential layout information memory 144 in step ST 607. In step ST 608, the CPU 12 displays a menu on the touch panel display 11 based on the selected and read layout information.

As described above, the user can display the functions selected frequently while using the control panel 1, by the learning function to display preferentially the often used functions on the control panel 1, the time required to select a function can be reduced.

In the above-mentioned first to fourth embodiments, all displays and inputs of the control panel 1 are performed on the touch panel display 11. However, as explained below, the embodiments are applicable also to the configuration that the displays and input of the control panel 1 are performed on a touch panel display 11a and a control unit 11b having physical keys.

FIG. 21 shows a control panel 1. The control panel 1 comprises a touch panel display 11a for displaying and inputting, and a control unit 11b having physical function keys. FIG. 22 shows the display area of the touch panel display 11a in the X-Y coordinates. The control unit 116 has numeral keys “0”-“9” and “clear”, “reset”, “stop” and “start” keys, used as physical function keys. The configuration explained on each of the above-mentioned embodiments is applicable also to the functions displayable on the touch panel display 11a.

The above-mentioned embodiments have been explained, for simplicity, in the case of switching the display of a menu in which the display appeared in the standby state is the highest level. However, the embodiments are applicable also to a menu for displaying hierarchically called functions. For example, when “magnify/reduce” is input, a menu to input several preset magnifications other than the user set magnifications is displayed. For the hierarchically read menu, too, the layout information of two function displays for left and right-sides, or can be used, the user can use this information as user layout information.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A displaying and inputting apparatus comprising:
a touch panel display;
a layout information memory which stores a plurality of layout information which sets a layout of a plurality of functions displayed on the touch panel display;
a selector which selects one layout information from said plurality of layout information; and
a control unit which displays the function on the touch panel display based on the layout information selected by the selector.

2. The displaying and inputting apparatus according to claim 1, further comprising a detector which detects the position moved from a predetermined position against an external unit, where the selector selects the layout information based on the position detected by the detector.

3. The displaying and inputting apparatus according to claim 2, wherein the detector detects the position moved by a slide mechanism.

4. The displaying and inputting apparatus according to claim 3, wherein the layout information memory stores the layout information corresponding to the right-side and the layout information corresponding to the left-side; the selector selects the layout information corresponding to the right-side when movement to the right-side by the slide mechanism is detected by the detector, and selects the layout information corresponding to the left-side when movement to the left-side is detected by the detector.

5. The displaying and inputting apparatus according to claim 2, wherein the detector detects the position moved by radio communication.

6. The displaying and inputting apparatus according to claim 5, wherein the layout information memory stores the layout information corresponding to the right-side and the layout information corresponding to the left-side; the selector selects the layout information corresponding to the right-side when movement to the right-side by radio communication is detected by the detector, and selects the layout information corresponding to the left-side when movement to the left-side is detected by the detector.

7. The displaying and inputting apparatus according to claim 1, further comprising a user layout information memory which stores the user layout information which sets a plurality of functions displayed on the touch panel display for each user corresponding to a registered user, wherein the selector selects from the layout information and the user layout information.

8. The displaying and inputting apparatus according to claim 1, further comprising an interface which connects a memory medium which stores user layout information which sets a layout of a plurality of functions displayed on the touch panel display, wherein the selector selects from the layout information and the user layout information.

9. The displaying and inputting apparatus according to claim 1, further comprising a selected times information memory which stores the selected times of the function displayed on the touch panel display, and a layout information generator which generates preferential layout information which sets a layout of often selected functions stored in the selected times information memory preferentially, wherein the selector selects from the layout information and the preferential layout information.
